(19) United States
(12) Patent Application Publication
(10) Pub. No.: US 2013/0218872 A1
(43) Pub. Date: Aug. 22, 2013

(54) DYNAMIC FILTERS FOR DATA EXTRACTION PLAN

(71) Applicant: BENZION JAIR JEHUDA, MITZPE NETOFA (IL)

(72) Inventor: BENZION JAIR JEHUDA, MITZPE NETOFA (IL)

(21) Appl. No.: 13/767,921

(22) Filed: Feb. 15, 2013

Related U.S. Application Data
(60) Provisional application No. 61/599,608, filed on Feb. 16, 2012.

(51) Int. Cl. G06F 17/30

(52) U.S. Cl. CPC G06F 17/30699
USPC 707/722

(57) ABSTRACT

Methods for creating deep web mining plans from dynamic content filters are described. Dynamic content filters allow for the creation of deep web mining plans that are able to be used even when the structure of documents including web pages and PDF files changes or to apply the same filters to different variants of the pages generated in deep web mining. By basing the dynamic filters on ontological and semantic information many common changes in web page structure, terminology and format can be made without preventing the extraction of data from these pages in deep web mining. Dynamic content filters may be created by persons without expertise in the creation of deep web mining data extraction plans.

### CROSS-REFERENCE TO RELATED APPLICATIONS

The present application claims priority under 35 USC §119 to Provisional Patent 61/599,608 filed on Feb. 16, 2012, titled DEFINING DEEP WEB MINING USING NORMAL WEB NAVIGATION METHODS, incorporated herein for all purposes.

### REFERENCES

¹Deep web: Bergman, Mike, The Deep Web: Surfacing Hidden Value. BrightPlanet, July 2000, http://brightplanet.com/wp-content/uploads/2012/03/12550176481-deepwebwhitepaper1.pdf.

### BACKGROUND OF THE INVENTION

Deep web mining¹ is the process of extracting data from web pages that are generated in response to user selections and inputs. The term deep web mining is used to distinguish between this type of information and the information that is commonly extracted by web search tools: shallow web data. Shallow web data is available without user actions which makes it accessible to search tools which just following links between pages (Google, Bing, etc.) to build a database of information available on the World Wide Web. It has been estimated that over 99 percent of the data that is available from the World Wide Web is only available as deep web data. Common instances of deep web data include product catalogs, pricing information, product selection, customer reviews, hotel and air travel availability, and product recommendations. Deep web mining commonly entails the creation of a deep web mining plan defining the methods used to generate pages containing links to other pages and/or data to be extracted.

Commonly a data extraction plan for use in deep web mining begins with the identification of a starting web page and the web page is presented in a web browser with additional areas dedicated to the deep web mining process which display the currently selected data and web pages and to show sample results of executing the deep web mining plan. The user selects web page elements that either control the generation of related web pages, link to other web pages to be processed or contain data to be extracted. Controls which are commonly used to control the generation of web pages include radio buttons, check boxes, option lists and text entry fields. This process is repeated for each web page to be included in the process until a source for all desired data has been defined. This information is then used to create a plan for iterating over the related web pages, including the generation of web pages from combinations of selected items and textual values (spidering) and the identified data elements are extracted (scraped). The extracted data is then commonly processed to remove site or page specific idiosyncrasies in data presentation such as the formatting or scaling of numbers or the order in which first names and last names are presented (normalization).

Once defined the deep web mining plan can be executed repeatedly to allow for the extraction of changing data, for example to find new products or to ensure that the extracted prices of the products are up to date.

### SUMMARY

The current state of the art presents several problems. Each type of web page to be visited must be defined by the user. Often, what appears to be a single web page to the user must be multiply defined to account for differences in presentation, for example to account for the presence of links to pages containing subsets of the items when they do not all fit on a single page or the lack of such links when all items fit on a single page, or to layout changes resulting from different image sizes, or table headings that depend on the type of product selected. Additionally, the deep web mining plans are inflexible and must be modified to allow for changes in the processed web pages. Often even a small change in the location of an item can result in a failure to find and process that item forcing a change to the deep web mining plan.

Embodiments of the present invention provide a means of addressing these problems by reducing the items that need to be manually identified by the user, relying on the semantics and similarity of web page elements to remove dependence on strict positioning or coding of the web page and providing an ability to recognize and adjust for differences between similar web pages or between different versions of the same web page.

### BRIEF DESCRIPTION OF THE FIGURES

FIG. 1 is a diagram of the one embodiment.

FIG. 2 is a flow diagram of the embodiment of FIG. 1.

FIG. 3 shows an example flow of matching field attributes to ontological classifications.

FIG. 4 is a flow diagram in which one or more filters are used to identify the location used in a filter.

FIG. 5 is a representation of the components of a possible data extraction plan.

FIG. 6 is a representation of the components of a possible filter.

FIG. 7 is a flow diagram of the process used in an embodiment for the extraction of data from a data document.

FIG. 8 is a flow diagram of a possible response to changes in the ontology used in the definition of a data extraction plan.

FIG. 9 is a flow diagram of a process of generating and selecting candidate filters.

FIG. 10 is a flow diagram of user validation of a data extraction plan.

FIG. 11A is a diagram of document elements such as may be used for localizing the application of filters in unstructured documents.

FIG. 11B is a diagram of document elements such as may be used for localizing the application of filters in structured documents.

FIG. 12 is a flow diagram of the process of applying filters to limit the application of other filters to portions of a document.

FIG. 13 is a flow diagram of the process of applying component filters.

FIG. 14 is a diagram of an alternate embodiment using an apparatus.

FIG. 15 is a flow diagram of an alternate embodiment using an apparatus.

FIG. 16 is a diagram of an alternate embodiment using a software application.

FIG. 17 is a flow diagram of an alternate embodiment using a software application.

FIG. 18 is a diagram of an alternate embodiment using a client/server architecture.

FIG. 19 is a flow diagram of an alternate embodiment using a client/server architecture.

### DETAILED DESCRIPTION

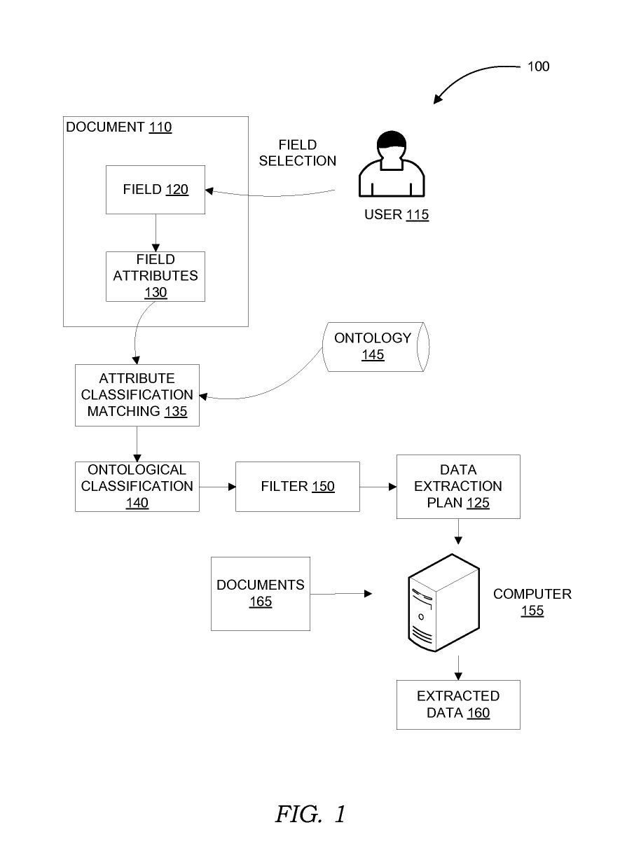

FIG. 1 is a diagram of an embodiment of the invention.

A document 110 is presented to a user 115 who selects a field 120 for inclusion in a data extraction plan 125. One example of a data extraction plan is a deep web mining plan used in the process of extracting data from the deep web. The field attributes 130 are identified and used in attribute classification matching 135 to identify an ontological classification 140 in one or more ontologies 145. The ontological classification 140 is incorporated into a filter 150 for inclusion in a data extraction plan 125. The data extraction plan 125 is used in a computer 155 to extract data 160 from one or more data documents 165. The term data document is used herein to specify a document to be processed for the extraction of data. The document 110 used in defining the data extraction plan 125 may also be used as a data document 165. The extracted data may include links to other documents and such links may be used to identify other data documents 165.

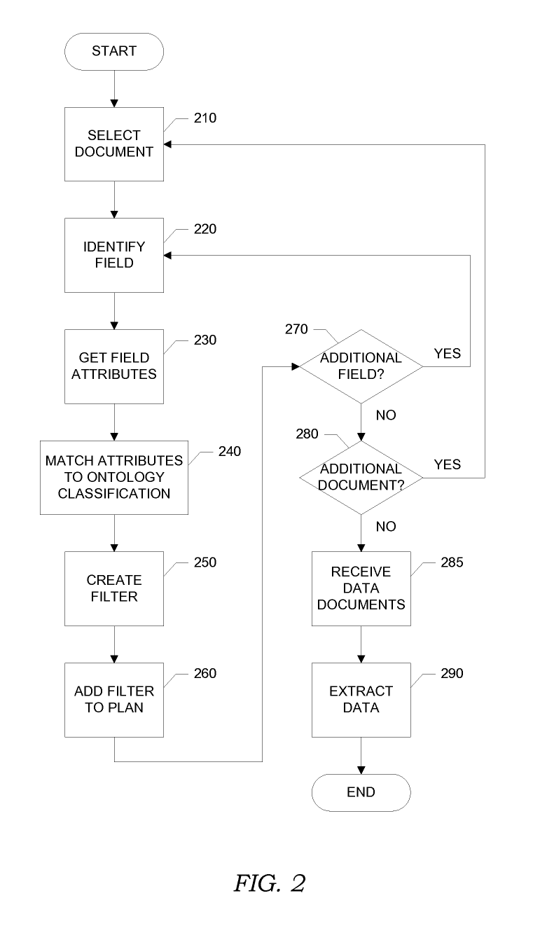

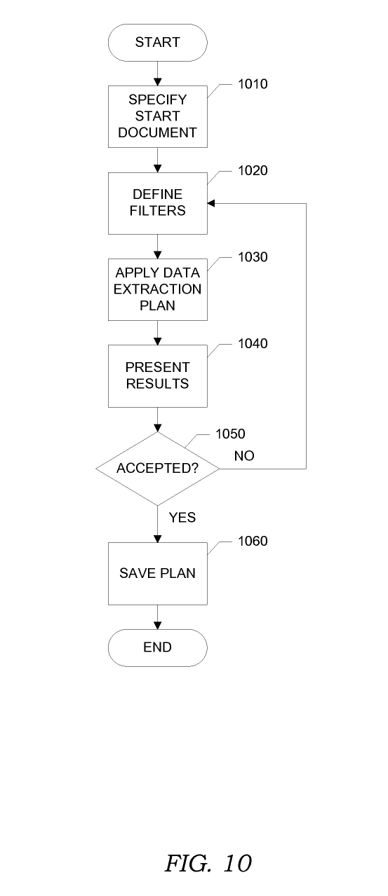

FIG. 2 is a flow diagram of the present embodiment. Creation of a data extraction plan 125 begins with the selection of a document 110 in step 210 which contains data and/or links for use in defining the data extraction plan 125. The user 115 identifies a field 120 containing data or a link to another document 110 in step 220. Identification of a field 120 may be done by selecting the field 120 in a graphical user interface, circling or highlighting a field in a document to be scanned, or otherwise differentiated from other portions of the document 110. The field attributes 130 associated with the identified field 120 are extracted from the document 110 in step 230. If the document 110 is machine readable the field attributes such as text style (e.g. font, size, color, bolding, underlining), context, value and location can be extracted from the document 110. If the document 110 is printed or partially an image (for example a form document with text entry fields on an image of the form's text, lines, boxes, etc.) the document 110 may need to be processed, for example by using Optical Character Recognition, to extract the field attributes. The field attributes 130 are matched to the attributes of various potential ontological classifications 140 stored in one or more ontologies 145 in step 240 to identify the ontological classifications 140 that match the field attributes 130. After one or more ontological classifications 140 are matched in step 240 a selection of an ontological classification 140 for verification of the ontological classification 140 may be done by the user as described below in reference to FIG. 10.

In step 250 the ontological classification matched in step 240 is used to create a filter 150. The filter 150 is used to identify data in documents that match the attributes of the identified field 120. The filter 150 is then added to a data extraction plan 125 in step 260. If additional fields are to be identified by the user as indicated in step 270 the steps 220 to 270 are repeated for each additional field 120 of document 110. If no additional fields 120 are to be identified in document 110, but other documents containing fields are to be included in the data extraction plan 125 the steps 210 to 280 are repeated as indicated by step 280. Once all documents 110 and fields 120 are identified and the corresponding filters 150 are added to the data extraction plan 125 data documents 165 (which may include the documents 110 used in steps 210 to 280) are received in step 285 and the plan is used in step 290 to extract data 160 in step 290 from the documents 110 received in step 285.

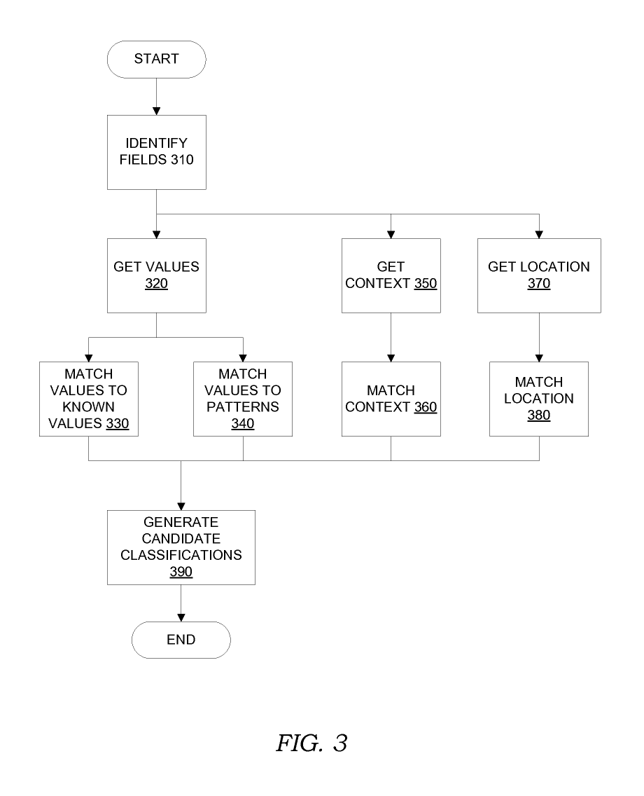

FIG. 3 shows an example flow of matching field attributes 130 to ontological classifications 140 such as might be done in step 240 of FIG. 2. In step 310 one or more fields 120 are identified. Whereas the previous descriptions of this embodiment are expressed in terms of a single field 120, it is often more useful to allow the selection of multiple fields 120. Processing multiple identified fields 120 allows for the use multiple data values and field attributes 130 in matching the user selection to ontological classifications 140. Multiple values and attributes allow for the comparison of the values and attributes to identify similarities and differences which can be used in matching ontological classifications 140.

In step 320 the values are extracted from the selected field or fields 120. The values may be processed to identify the type of value as textual, numeric, physical, etc. The value or values may then be matched to either known values associated with ontological classifications in step 330 or matched to patterns in step 340. Matching of values to known values is useful when the ontological classification contains a limited set of possible or common values. For example, an ontological classification of US State names can reasonably contain the names of all the US States for use in matching values found in the field or fields 120. Similarly, an ontological classification of “Last Names” can contain a set of the most frequent last names of people in the US or some other geographic region (or the world). Matching to common values demonstrates the utility of processing values from multiple fields 120 since a single value might not be in the set of common last names even though it is a person's last name, but even with a small number of values one or more values could be expected to be found in the set of common last names if the fields are intended to contain last names. Matching of values to patterns could be commonly done by including in the ontological classification one or more patterns for acceptable values. Often these patterns are expressed as regular expressions or finite automata. The use of patterns in the matching in step 340 is more flexible than the matching to known values in step 330 due to the greater ability of patterns to define acceptable values without needing the enumeration of the values or even of common values. For example, prices may be recognized by a pattern that begins with a dollar sign, contains a numeric value, and contains an optional 2 digits after a decimal point. A more general “Monetary Value” ontological classification could match similar values beginning with a Frank or Yen symbol, or ending with a value such as “Pounds”, “Franks”, “Swiss Francs”, etc.

The context of the selected fields 120 may also be used in matching to ontological classifications. The context of a field 120 could include a label associated with the field, a header or a table row or column containing the fields, the title of a table or document section containing the selected fields, or other value associated with the selected fields 120. Often changes in style can be used to identify contextual elements in the document. For example, a table may use one font or font size for data values and another font, font size, bolding, color or background color for row and column headings. Similarly, larger fonts or bolding is often used to indicate table or section titles. By using style to identify contextual values within the fields 120 selected by the user 115 it is possible for the user 115 to indicate the context of the data to be extracted at the same type as the sample values to be used (for example in steps 330 and 340) in identifying the ontological classification. Context matching in step 360 includes identification of the type of context, for example a row/column header, label, title or other related fields and matching the value of these items to the context identified in the ontological classification 140. For example, an ontological classification 140 may include one or more keywords useful in identifying related context such as “First Name” for a “Person First Name” ontological classification 140 or “State” for a “US State” ontological classification 140. Multiple keywords or phrases may be included since often a given ontological classification may be labeled with different terms such as “Zip”, “Zip code”, “Zip+4”, and “Postal Code”.

The location of the selected fields 120 may also be used in matching to ontological classifications. The location of a field 120 could include the page, column, paragraph, line, frame, box, list, group, table or other structuring element of the document. The location of a field 120 may also include non-visible elements of the document 110 such as embedded comments, class tags and meta-tags. The location can also include a complete or partial ordering of such elements in a hierarchy, for example, the third paragraph of the second column of the fifth page of the document 110 or the table of the right side frame in the document 110. Structured document representations such as XML or HTML may use the document structure to define locations. Unstructured documents such as PDF or a scanned image may require the application of Optical Character Recognition or statistical methods to identify the elements used to identify field 120 locations. The field locations identified in step 370 are matched with field location constraints or indicators associated with ontological classifications 140 in step 380. In unstructured documents elements within pages may need to be recognized from the layout of the text on the page. For example, columns may be identified by recognizing regions of white space between sections of text in each line on a page. Similarly, paragraphs may be recognized by additional space before or after the paragraphs or space before and/or after the text in a paragraph (i.e. indentation before the first word of a paragraph or extra space following the last word in a paragraph). Other elements such as bullet symbols, or sequential numbers beginning successive paragraphs may also be used to recognize lists of items. Tables may be recognized by either lines or spacing between cells of the table and/or style changes between the row and/or column headings and the data values in the cells of the table. The use of a filter 150 based on an ontological classification 140 can facilitate the identification of tables by recognizing values that are wrapped to fit into the space of a cell. For example, if a cell contains a person's name, outside of a table the “First Name, Middle Initial, and Last Name” components of a filter 150 would be expected to be in sequence within a single line or wrapped such that the text matching the first components appear at the end of a line and the text matching the following components appear at the beginning of the next line. In a table the text matching the components may be wrapped within the cell leading to the text matching the first components appearing above the following components within two or more lines. This type of wrapping of text in the interior of two or more lines provides an indication that the matched text is in a cell of a table. Such cells can be identified when the matching of the content of a portion of one line to an ontological classification 140 such as “First Name” which is also a component of another ontological classification 140 such as “Person Name”. The hierarchical structure of ontological classifications 140 can then trigger a search for the other components (“Middle Initial” and “Last Name”) of the containing ontological classification 140 (e.g. “Person Name”). If the other components are found in the same line, or at the beginning of the next line when the text matched to the ontological classification “First Name” appears at the end of a line, there is no indication that the field is a “Person Name” in a table cell. If the other components are found in the same line starting at about the same position in the line, there is a strong indication that the field is a “Person Name” in a table cell. A similar identification of document structure including columns and tables may be based on a grammatical analysis of the text to identify the grammatically allowable continuations of wrapped text at the end of lines, columns or table cells.

The matching of values in steps 330 and 340, the matching of context in step 360 and the matching of location in step 380 are all or some used in matching the fields 120 selected in step 310 to ontological classification in step 390. The matching may be exact or based on a preponderance of the matching. In some cases, allowing the matching of an ontological classification 140 to the fields selected in step 310 even when some characteristics such as value, context or location are not matched may be useful in generating candidate ontological classifications when the fields selected in step 310 include missing or incorrectly entered values.

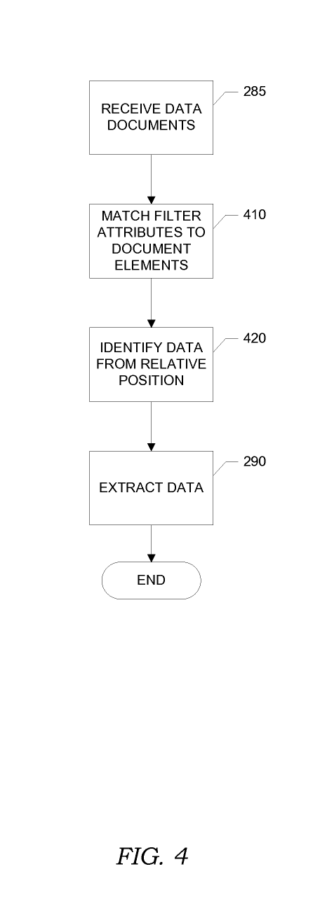

FIG. 4 is a flow diagram in which one or more filters are used to identify the location used in a filter. Often a field 120 can best be identified for extraction through the use of one or more filters 150. The filters 150 used for identifying other fields may be used for only this purpose or may also be used to extract data 160. The use of filters as criteria for extracting data allows for the definition of a relative location for the extraction of data. One example of where relative positioning can be advantageous is where a sequence of fields defines related data. For example, three fields might contain a person's name split into the first name, middle initial and last name. The contents of the middle initial field will usually be single letters that are of little use in matching the field to an ontological classification 140 of “Middle Initial”, but the proximity of a filter 150 using an ontological classification 140 of “First Name” and a filter 150 using an ontological classification 140 of “Last Name” is highly indicative of the field 150 as containing data matching an ontological classification 140 of “Middle Initial”. Similarly, when extracting data, the matching of the “First Name” and “Last Name” filters 150 can be used to identify the location of the “Middle Initial” fields 150.

FIG. 4 is a partial expansion of FIG. 2 with two steps added between steps 285 and 290 of FIG. 2. In step 410 the filters 150 used to identify the relative location of the fields for data extraction are applied to the received data documents 165 to determine the appropriate location for applying filters 150 using relative locations. The appropriate location for applying the filters 150 using relative locations are then determined by applying any offsets defined. The offsets are used to identify the location for the extraction of data and may include any indication of one position in the data document 165 relative to another position in the data document 165. Example relative positions include one or more fields above, below, to the right or left of the locating field 150, one or more paragraphs, lines, and/or sections before or after the locating field 150, one or more columns right or left of the locating field, one or more rows or columns above or below or right or left of the locating field, etc.

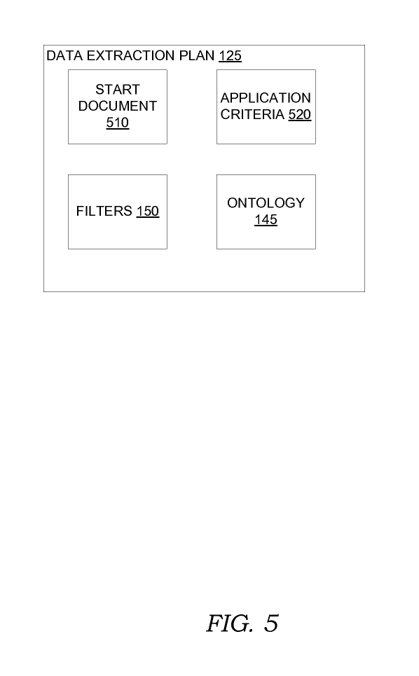

FIG. 5 is a representation of the components of a possible data extraction plan 125 used in deep web mining. Generally a data extraction plan 125 will include an indication of one or more start documents 510. The start documents provide one or more documents at a known location that does not change with the content of the documents. Other data documents 165 are found as described in reference to FIG. 1 by extracting links between documents and using these links to retrieve other documents. The application criteria 520 defines conditions under which the data extraction plan 125 is used to extract data 160. Commonly data extraction plans 125 used in deep web mining are invoked either periodically (e.g. daily, weekly, monthly) or when some conditions are met. The data extraction plan will also commonly include the filters 150 used to extract data 160 from the data documents 165 and the one or more ontologies 145 used in defining and applying the filters. The data extraction plan may also include other elements such as a database in which to store the extracted data that are outside the scope of this embodiment.

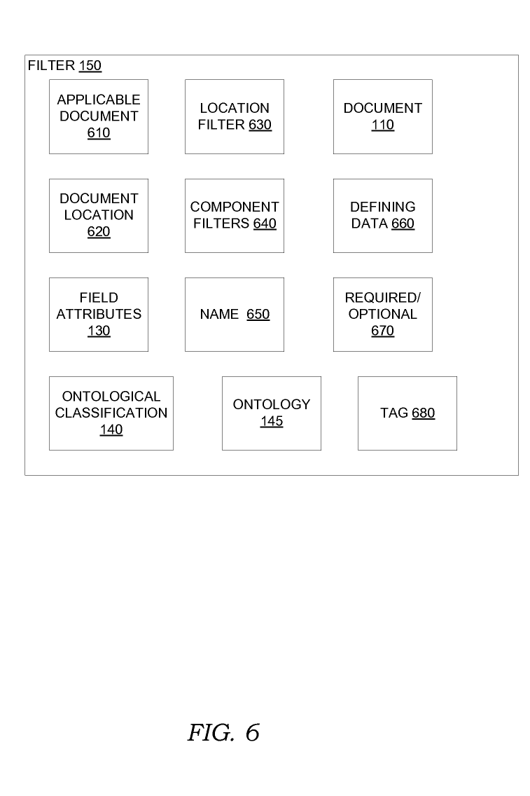

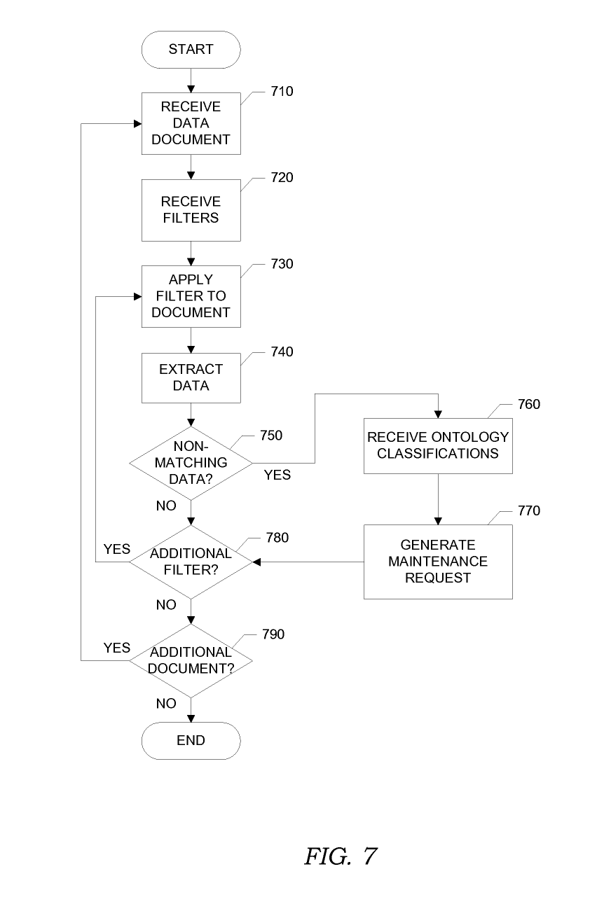

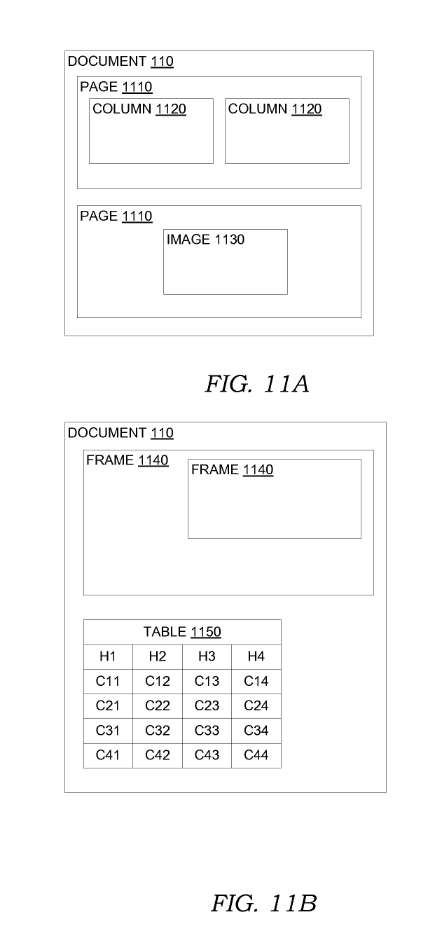

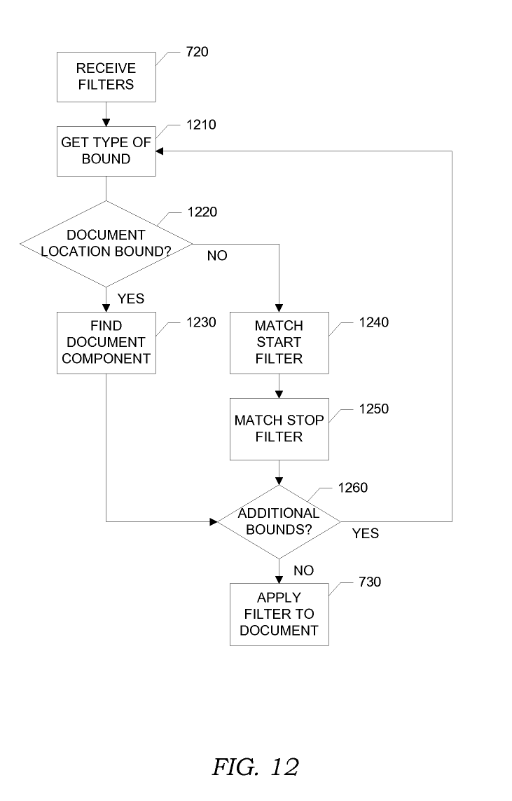

FIG. 6 is a representation of the components of a possible filter 150 as used in this embodiment. Generally a filter will contain an indication of the applicable document 610 or documents for which the filter may be used in the extraction of data. The indication of applicable document 610 might be done by providing a Uniform Resource Indicator to a Web Page or online document, a document title, a file name or other means of identifying documents. The indication of applicable document may be specific or a pattern that is applied to the document. The filter 150 will commonly also include an indication of the document location 620 where the filter can be applied. The document location is a more directed location than is used in matching fields to ontological classifications as described above in reference to steps 380 and 390 of FIG. 3. A document location 620 on a larger scale such as pages, document sections or web sites often allows the more efficient application of filters to data documents 165 since only a small portion of the data document 165 must be searched for data by matching the field attributes 130 to the ontological classification 140. The use of a document location 620 is further described in reference to FIG. 11A and FIG. 11B. As described above the filter 150 will also include the field attributes 130 specific to the field and the ontological classification 140 identified in the definition of the filter. The field attributes 130 and information from the ontological classification 140 are used to identify valid data matching the filter when the filter is applied to extract data 160 from data documents 165. The ontological classification may also be used to associate data extracted using the filter with an ontological classification 140 to provide an indication of the type of the data. As described below in reference to FIG. 7, the association of an ontological classification 140 with the extracted data 160 can be applied even in cases where the extracted data 160 would not otherwise be recognized as matching the ontological classification 140. As for example if a value extracted in a list of “City Name”s might not be in the known values of the “City Name” ontological classification 140. In this case the association of the previously unknown value as associated with the “City Name” ontological classification 140 can be used in further processing of the value as the name of a city and not as just a string of characters. As described in reference to relative locations in FIG. 4 the filter may contain location filters 630 that are used to define either the bounds of the application of the filter 150. Location filters 630 will be described in further detail in reference to FIG. 12. The filter 150 may also contain one or more component filters 640. Component filters 640 are used to define data which has components that also have ontological classifications 140. For example, a “Mailing Address” may be defined in terms of a “Street Address” (itself possibly defined in terms of a “Street Name”, “Building Number”, “Apartment Number”, “Floor”, etc.) a “City”, a “State”, and a “Zip Code”. The use of component filters 640 allows the reuse of the ontological classifications 140 to create multiple higher level ontological classifications 140. For example, a “Mailing Address” ontological classification 140 might be defined using various combinations of the above component ontological classifications to allow for addresses for individual homes, businesses, apartments, offices, post office boxes, national and international addresses. The matched component ontological classifications will be used to create component filters 640 using the same process as described in this embodiment. As described above in reference to FIG. 1 and FIG. 2, the filter 150 will also include the ontological classification 140 on which the filter 150 is based and the ontology 145 or ontologies 145 in which the ontological classification is defined. Similar to the ontological classification 140 associated with the filter 150, the filter 150 may include tags 680 which can be used for various purposes including the identification of the data type where an ontological classification 140 is not available or is not applicable, or to disambiguate fields 120 matching the same ontological classification 140 by the creation of multiple filters 150 using the same ontological classification 140 but different tags 680.

Often the filter 150 will also include a name 650 for use in identifying the filter for various purposes including the reuse or modification of the filter. Filters 150 may also include an indication if the filter 150 is required or optional 670. Optional filters are often used when defining component filters 640 since this can allow the definition of a single filter 150 that allows for different combinations of components.

A filter 150 may also include an indication of the document 110 used in the definition of the filter and the data extracted for use in defining the filter 660. Inclusion of the document 110 or a method of retrieving the document 110 can facilitate the verification or maintenance of the filter. The defining data 660 is often of use in identifying changes to the structure of the defining document 110 as will be discussed in reference to FIG. 7.

FIG. 7 is a flow diagram of the process used in an embodiment for the extraction of data from a data document 165. The process begins with the receipt of a data document 165 in step 710 and the filters to apply to the document are received in step 720. As discussed in reference to FIG. 6 applicable document 610 or document location 620 and FIG. 12 the application of filters 150 in step 720 may be limited based on the document 165 or location in the document 165. In step 730 a filter 150 received in step 720 is applied to the document by matching the characteristics defined in the ontological classification 140 associated with the filter 150 and the field attributes 130 used in defining the filter 150. In step 740 the data in the portion of data document 165 is extracted and the extracted data is matched to the ontological classification 140 associated with the filter 150. The extracted data will commonly be associated with the ontological classification 140 to provide an identification of the type of data. If any of the extracted data does not match the ontological classification 140 associated with the filter 150 the data extracted it may be matched to other ontological classifications 140 as described in reference to FIG. 3 when defining a data extraction plan 125. If the non-matching extracted data matches a known ontological classification it may indicate that the data extraction plan 125 should be modified to use a more inclusive ontological classification 140. For example, if the data used in defining the data extraction plan 125 contained only US 5 digit zip codes the ontological classification 140 associated with the filter 150 might be “ZIP Code”. If the non-matching data is a six character string such as “C1N 2A3” which matches an ontological classification 140 of “Postal Code” (i.e. a classification that matches both US and Canadian postal codes) a maintenance request for the data extraction plan 125 may be generated in step 780. Similarly, if the non-matching data does not match any ontological classification 140 or only matches ontological classifications 140 that are unrelated to the ontological classification 140 associated with the filter 150 used to extract data in step 740, a maintenance request for the extracted data may be generated to indicate the possible presence of corrupt or incorrectly entered values in the extracted data. Similarly, if the non-matching data does not match the ontological classification 140 associated with the filter 150 used to extract data in step 740 but a minor change in the pattern in the ontological classification could be made to allow the matching of the non-matching data, or the ontological classification 140 associated with the filter 150 used known value matching as described in reference to FIG. 4 step 330, a maintenance request for the ontological classification may be generated to indicate that the pattern be modified or the non-matching value be added to the list of known values associated with the ontological classification 140 associated with the filter 150. The generation of maintenance requests may lead to either manual changes to the filter 150, ontological classification 140 or the extracted data, or to automatic changes to these or other elements of the embodiment.

After extraction of data and possible processing of non-matching data step 780 tests if additional filters may be applied to the data document 165. If additional filters 150 may be applied to the data document 165 the steps 730 to 780 are repeated with one of the additional filters 150. If no additional filters 150 can be applied to the data document 165 received in step 710 step 790 tests if any additional data documents 165 can be processed by the data extraction plan 125. As discussed above, the additional data documents may be indicated in the start document 510 component of the data extraction plan 125, or may be identified by links extracted from one or more of the data documents 165 processed by application of the data extraction plan 125. If there is an additional document steps 710 to 790 are repeated for the additional data document 165. If there are no additional data documents 165 the data extraction process is complete.

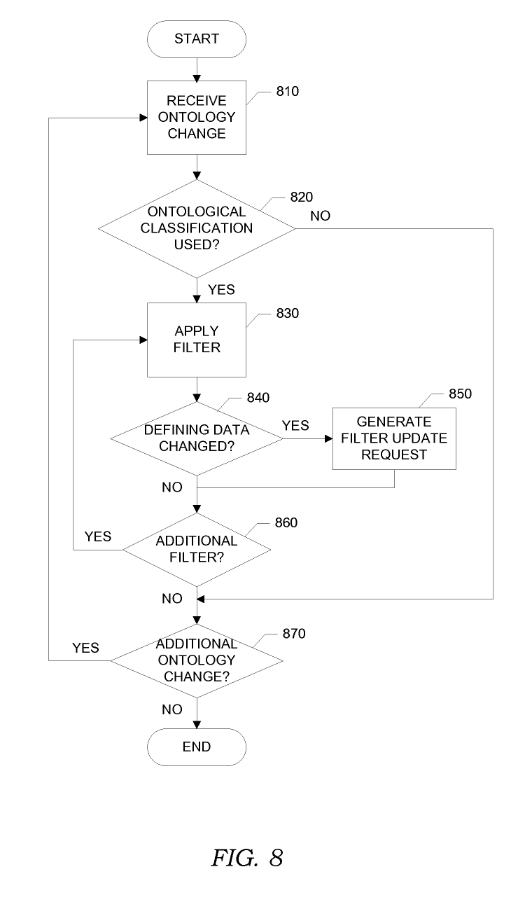

FIG. 8 is a flow diagram of a possible response to changes in the ontology used in the definition of a data extraction plan. The process 800 starts with the receiving of an ontology change in step 810. A test is made in step 820 to determine whether an ontological classification 140 associated with a filter 150 has been changed. If an ontological classification 140 associated with a filter 150 has been changed the filter is again applied to the source document 110 as described in reference to FIG. 3 to get the values, context and location of the field or fields 150 associated with the filter 150 in the defining document 110 in step 830. A test is then made in step 840 to determine if the data used to define the filter (defining data 660 in FIG. 6) has changed. If the defining data 660 has changed a filter update request is generated in step 850 indicating that either the change to the ontology has possibly modified the applicability of the filter 150 associated with the changed ontological classification 140 or that the defining document 110 has changed. The filter update request may be further processed manually or automatically.

In step 860 a test is made for additional filters 150 based on the modified ontological classification 140 and if any additional filters exist steps 830 to 860 are repeated for each such filter. In step 870 a test is made for additional ontology changes and if any additional ontology changes exist steps 810 to 870 are repeated for each such ontology change. If an ontology change does not affect any ontological classifications 140 on which one or more filters 150 are based steps 830 to 860 are skipped.

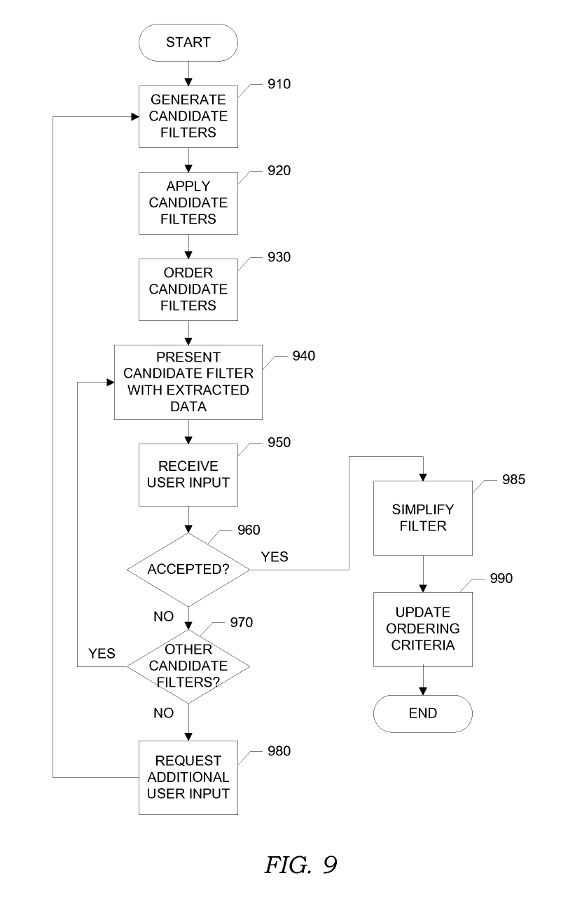

FIG. 9 is a flow diagram of a process of generating and selecting candidate filters. The process of identifying a filter 150 from user selected fields 120 may result in the generation of multiple possible candidate filters 150 from which the user can select the filter 150 which best identifies the fields from which data is to be extracted. The process of generating and selecting candidate filters begins with the generation of candidate ontological classifications 140 from matching the field attributes 130 and values as described above in reference to FIG. 3. Candidate filters are generated from the candidate ontological classifications 140 in step 910. Additionally, candidate filters 150 may be generated from the candidate ontological classifications 140 using various interpretations of the identified fields 120. For example, a selection of a single field 120 in a table may be indicative of the single field 120, all such fields 120 in a row, all such fields 120 in a column, or all fields 120 in the table. Even multiple selected fields 120 may indicate a range of values between the selected fields 120, all values within the same rows or columns of the selected fields 120 or all fields 120 in the table. The same issue applies when the fields are values in a list 120 where the selected field 120 or fields 120 may indicate the whole list, all values between the selected fields 120 or only the selected fields 120 for example.

The candidate filters 150 are applied to the defining document 110 to extract the data identified by each candidate filter 150 in step 920. In step 930 the candidate filters are ordered. Possible criteria for ordering include the number of values identified by the filter, the type of matching used to identify the values or the interpretation of the selected fields 150 (e.g. as indicating a whole table, as indicating a single row, as indicating multiple rows, etc.). In step 940 the values identified by one of the candidate filters is presented to the user 115 and the user 115 indicates an acceptance or rejection of the values identified by the candidate filter 150. If the user 115 indicates that the values identified by the candidate filter 150 are not accepted (rejected) as tested in step 960, a test is made in step 970 for other candidate filters 150. If other candidate filters were generated in step 910 they are presented to the user in step 940 until either all candidate filters 150 are presented or the user accepts the values identified by a candidate filter. If all candidate filters 150 are rejected the user may be requested to modify the selected fields 120. Steps 910 to 980 may be repeated until a candidate filter is accepted in step 950 or the user 115 aborts the process. When the user input received in step 950 indicates acceptance of a candidate filter 150 in step 950 the candidate filter is simplified if possible in step 985. Often candidate filters will include redundant attributes which may be simplified without changing the fields matched by the candidate filter. For example, a filter for extracting data from a table may be able to recognize the column of the table from any of the heading of the column, the index of the column, the type of the values (for example images verses text or monetary units verses length or weight values), the font style of the text representing the values, or the values themselves (i.e. when the values are all known values). Matching multiple such attributes in the data extraction process would be redundant and less efficient than matching using a single or a few such attributes. The simplification of the filter in step 985 entails the identification and removal of such redundant attributes from the approved filter 150.

Since each user approval in step 950 provides information on the process of generating filters through the selection of fields 120 in the source document 110 the criteria used in step 930 may be updated in step 990 to improve the ordering of candidate filters 150. For example, each candidate filter that was presented to the user and rejected in step 950 may result in decreasing a weight associated with each attribute or interpretation of the user's intent as described above. Similarly, the weights associated with the attributes and interpretation of the user's intent as described above may be increased for the filter 150 approved by the user in step 950. Such a mechanism or any similar machine learning method may be applied to improve the ordering criteria used in step 930 leading to the presentation of the most likely candidate filters 150 to the user before the presentation of less likely candidate filters 150 thereby improving the process of generating and selecting candidate filters 150 for use in a data extraction plan 125. One such example where such weight modification will demonstrate utility is where multiple data extraction plans are created for the same or similar documents, for example when multiple users 115 create data extraction plans 125 for a popular web site (document 110). In this case the weights modified from the selections of users 115 creating prior data extraction plans 125 will significantly facilitate the creation of subsequent data extraction plans 125.

FIG. 10 is a flow diagram of user validation of a data extraction plan. Commonly the process of creating a data extraction plan 125 begins with the specification of a start document 110 in step 1010. The user then defines filters 150 as described for this embodiment in step 1020. Once the individual filters 150 have been selected as described in reference to FIG. 9 they are applied to all or a portion of the data documents 165 in step 1030. Often the data extraction plan 125 will be applied to only a portion of the data documents 165 or to a portion of the fields 120 in the data documents 165 in order to provide data for use in validating the data extraction plan 125 without forcing the user 115 to wait for the completion of data extraction from the complete set of data documents 165. In step 1040 the results of the application of the data extraction plan 125 are presented to the user 115 for approval. If the user accepts the presented data in step 1050 the plan may be saved in step 1060. If the plan is rejected (not accepted) in step 1050 the user may define or modify filters by repeating the process from step 1020.

FIG. 11A is a diagram of document elements such as may be used for localizing the application of filters in unstructured documents. Many document formats such as PDF do not include elements for structuring the document below the level of pages and columns such as could be used to identify tables or lists of values. The recognition of columns, tables, lists and other structural elements in unstructured documents such as PDF files is described above in reference to FIG. 3. Filters 150 applied to these documents 165 may be localized by page 1110, column 1120 or some subsection of these or other elements possibly in combination with field attribute matching as described in reference to FIG. 3 above. Pages 1110 usually do not support nesting but columns 1120 are nested within pages. In some cases images 1130 may also be identified to allow text to flow around images.

FIG. 11B is a diagram of documents such as may be used for localizing the application of filters in structured documents. Many document formats such as XML or HTML include elements used for structuring the document 165 such as frames, lists or tables. Filters 150 applied to these documents may be localized by referring to elements such as a frame 1140 (which may be nested as shown in FIG. 11B) or the structural elements such as a table 1150.

FIG. 12 is a flow diagram of the process of applying filters to limit the application of other filters to portions of a document. When a filter 150 is received in step 720 a first check may be done to identify if the filter has a document location 620 and/or location filter 630 in step 1210. The type of the bound is determined in step 1220 and if the bound is based on a document location such as those described in FIG. 11 the document location is found in step 1230. If the type of the bound is a pair of filters that define the start and end of the document in which the filter is applicable the start filter is matched in step 1240 and the end filter is matched in step 1250. Additional bounds are tested for in step 1260 and if any additional bounds are remaining steps 1210 to 1260 are repeated for each bound in the filter 150. When all bounds have been applied the filter is applied in step 730.

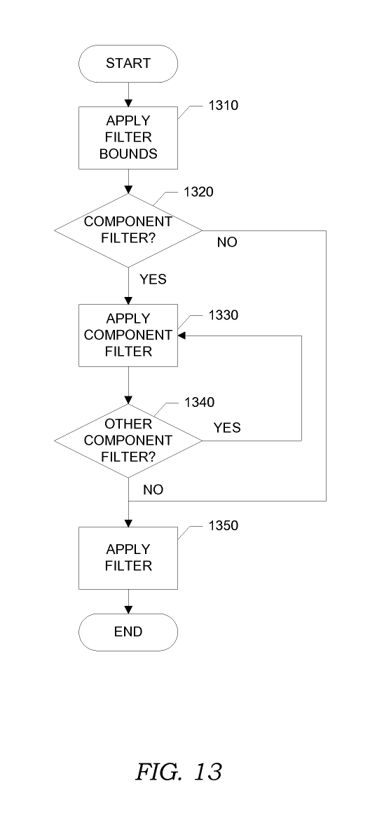

FIG. 13 is a flow diagram of the process of applying component filters. When a filter 150 is to be applied, for example in step 730 of FIG. 7, a check is made to determine if the filter contains component filters 640 in step 1320 possibly after applying any filter bounds in step 1310 as described in reference to FIG. 12. If the filter has component filters 640 a component filter is applied in step 1330. A test is then made in step 1340 for additional component filters 640. If a component filter 640 has not been applied step 1330 is repeated with the unapplied component filter 640. When all component filters 640 have been applied the containing filter 150 is applied in step 1350. The containing filter may be optional or not identify any fields 120 for data extraction if the data extraction is done by the component filters 640 alone. Component filters are often used where an ontological classification 140 associated with the filter 150 is defined wholly or partially in terms of other ontological classifications. For example, an ontological classification 140 of “Mailing Address” may be defined in terms of “Street Address”, “City”, “State” and “Zip Code” ontological classifications 140. Component filters 640 can also be of use where the data in a field 120 may be wrapped or split between lines. For example, if a table column is not wide enough to hold a person's complete name, the name may be split into separate lines between the first name and middle initial or between the middle initial and last name. The construction of a filter 150 from a “Person Name” ontological classification 140 resulting in component filters 640 for the “First Name”, “Middle Initial” and “Last Name” can allow matching of text to individual components of the filter even when matched text appears in the document 165 in separate lines. In some documents such as those using a PDF format, the recognition of component filters 640 may be the best way to recognize data on different lines are belonging to one ontological classification if lines are not present between cells of a table since the PDF format does not have structural elements identifying cells of a table.

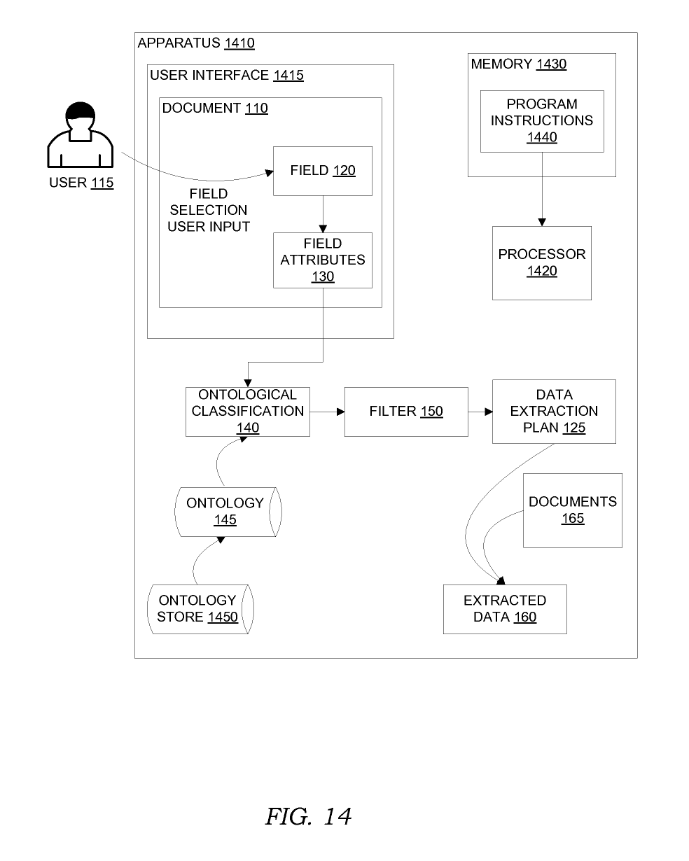

FIG. 14 is a diagram of an alternate embodiment using an apparatus. The apparatus 1410 contains a user interface 1415, processor 1420 and a memory 1430. The memory 1430 contains program instructions 1440 which are executed by processor 1420 to implement the process of this embodiment.

A document 110 is presented by the user interface of 1415 of apparatus 1410 to a user 115 who selects a field 120 for inclusion in a data extraction plan 125. The field attributes 130 are identified by the apparatus 1410 and used in attribute classification matching 135 to identify an ontological classification 140 in one or more ontologies 145 from an ontology store 1450. The ontological classification 140 is incorporated into a filter 150 for inclusion in a data extraction plan 125. The data extraction plan 125 is used in a computer 155 to extract data 160 from one or more data documents 165. The term data document is used herein to specify a document to be processed for the extraction of data. The document 110 used in defining the data extraction plan 125 may also be used as a data document 165. The extracted data may include links to other documents and such links may be used to identify other data documents 165.

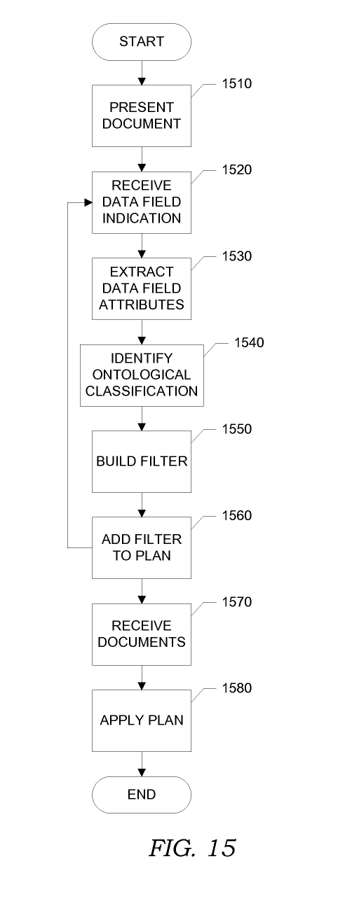

FIG. 15 is a flow diagram of an alternate embodiment using an apparatus. Creation of a data extraction plan 125 begins with the presentation of a document 110 by user interface apparatus 1415 in step 1510 which contains data and/or links for use in defining the data extraction plan 125. The apparatus 1410 receives from user 115 an indication of a field 120 containing data or a link to another document 110 in step 1520. Identification of a field 120 may be done by selecting the field 120 in a graphical user interface, circling or highlighting a field in a document to be scanned, or otherwise differentiated from other portions of the document 110. The field attributes 130 associated with the identified field 120 are extracted from the document 110 in step 1530. If the document 110 is machine readable the field attributes such as text style (e.g. font, size, color, bolding, underlining), context, value and location can be extracted from the document 110. If the document 110 is printed or partially an image (for example a form document with text entry fields on an image of the form's text, lines, boxes, etc.) the document 110 may need to be processed, for example by using Optical Character Recognition, to extract the field attributes. Potential ontological classifications 140 stored in one or more ontologies 145 in step 240 are matched to the attributes of the identified field 120 to identify the ontological classifications 140 that match the field attributes 130 of the field 120. After one or more ontological classifications 140 are identified in step 1540 a selection of an ontological classification 140 or verification of the ontological classification 140 may be done by the user as described above in reference to FIG. 9.

In step 1550 the ontological classification identified in step 1540 is used to create a filter 150. The filter 150 is used to identify data in documents that match the attributes of the identified field 120. The filter 150 is then added to a data extraction plan 125 in step 1560. If additional fields are to be identified by the user steps 1520 to 1560 are repeated for each additional field 120 of document 110. If no additional fields 120 are to be identified in document 110, but other documents containing fields are to be included in the data extraction plan 125 the steps 1520 to 1560 are repeated for each document 110. Once all documents 110 and fields 120 are identified and the corresponding filters 150 are added to the data extraction plan 125 data documents 165 (which may include the documents 110 used in steps 1510 to 1560) are received in step 1570 and the plan is used in step 1580 to extract data 160 in step 290 from the documents 110 received in step 1570.

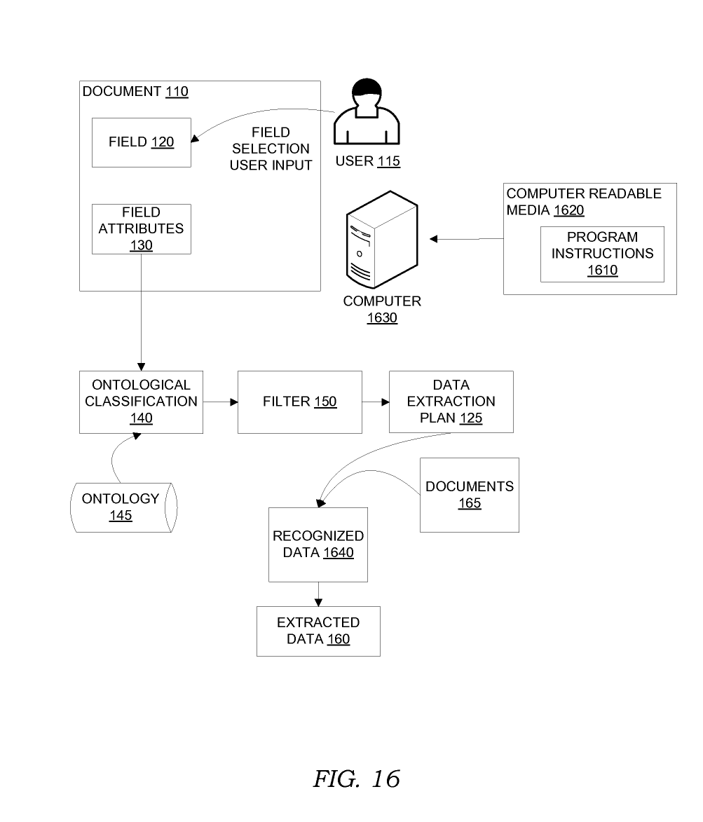

FIG. 16 is a diagram of an alternate embodiment using a software application. The software application resides in program instructions 1610 stored in a computer readable media 1620. The program instruction 1610 are executed on a computer 1630 to implement this embodiment.

A document 110 is presented by the software application to a user 115 who selects a field 120 for inclusion in a data extraction plan 125. The field attributes 130 are identified and used in attribute classification matching 135 to identify an ontological classification 140 in one or more ontologies 145. The ontological classification 140 is incorporated into a filter 150 for inclusion in a data extraction plan 125. The data extraction plan 125 is used in a computer 1630 to recognize data 1640 in data documents 165 and the recognized data is extracted to create extracted data 160 from one or more data documents 165. The term data document is used herein to specify a document to be processed for the recognition and extraction of data. The document 110 used in defining the data extraction plan 125 may also be used as a data document 165. The extracted data may include links to other documents and such links may be used to identify other data documents 165.

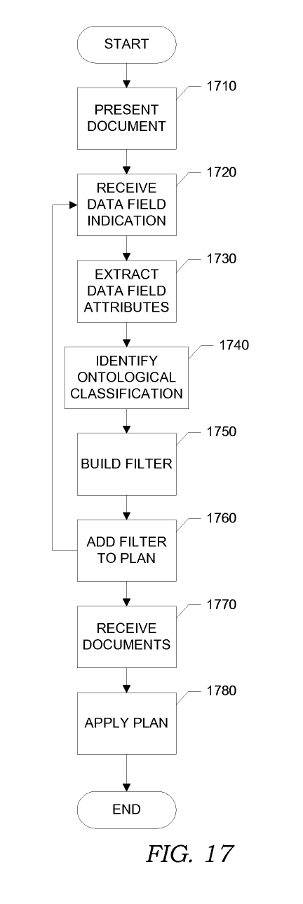

FIG. 17 is a flow diagram of an alternate embodiment using a software application. Creation of a data extraction plan 125 begins with the presentation of a document 110 in step 1710 which contains data and/or links for use in defining the data extraction plan 125. The software application receives from user 115 an indication of a field 120 containing data or a link to another document 110 in step 1720. Identification of a field 120 may be done by selecting the field 120 in a graphical user interface, circling or highlighting a field in a document to be scanned, or otherwise differentiated from other portions of the document 110. The field attributes 130 associated with the identified field 120 are extracted from the document 110 in step 1730. If the document 110 is machine readable the field attributes such as text style (e.g. font, size, color, bolding, underlining), context, value and location can be extracted from the document 110. If the document 110 is printed or partially an image (for example a form document with text entry fields on an image of the form's text, lines, boxes, etc.) the document 110 may need to be processed, for example by using Optical Character Recognition, to extract the field attributes. Potential ontological classifications 140 stored in one or more ontologies 145 in step 240 are matched to the attributes of the identified field 120 to identify the ontological classifications 140 that match the field attributes 130 of the field 120. After one or more ontological classifications 140 are identified in step 1740 a selection of an ontological classification 140 or verification of the ontological classification 140 may be done by the user as described above in reference to FIG. 9.

In step 1750 the ontological classification identified in step 1540 is used to create a filter 150. The filter 150 is used to identify data in documents that match the attributes of the identified field 120. The filter 150 is then added to a data extraction plan 125 in step 17560. If additional fields are to be identified by the user steps 1720 to 1760 are repeated for each additional field 120 of document 110. If no additional fields 120 are to be identified in document 110, but other documents containing fields are to be included in the data extraction plan 125 the steps 1720 to 1760 are repeated for each document 110. Once all documents 110 and fields 120 are identified and the corresponding filters 150 are added to the data extraction plan 125 data documents 165 (which may include the documents 110 used in steps 1710 to 1760) are received in step 1770 and the plan is used in step 1780 to extract data 160 in step 290 from the documents 110 received in step 1770.

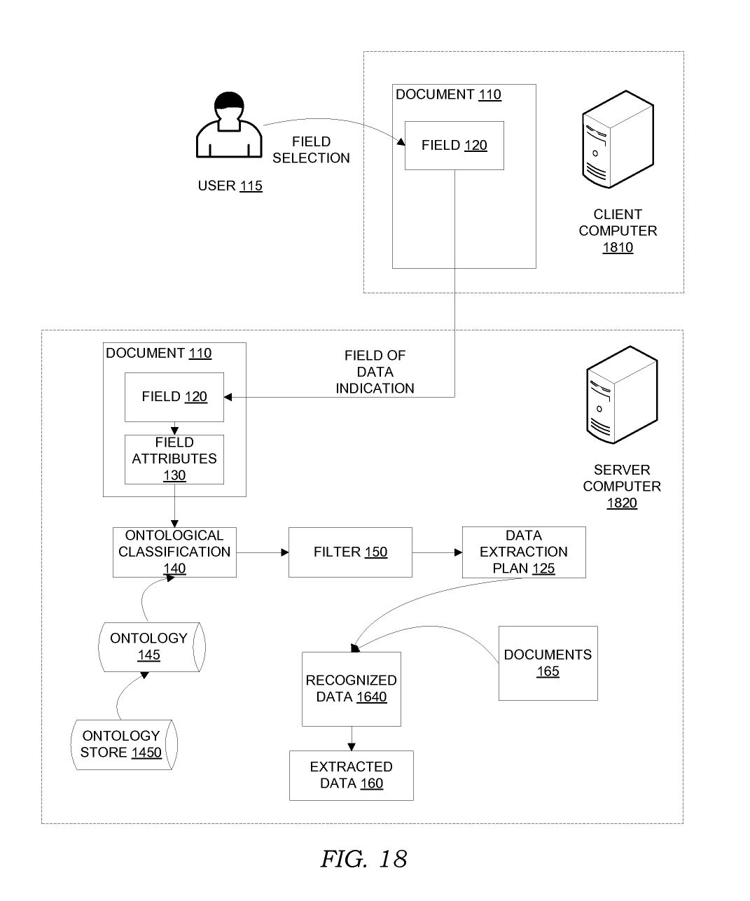

FIG. 18 is a diagram of an alternate embodiment using a client/server type architecture. This embodiment uses a client/server architecture whereby the user 115 interacts with a client computer 1810 and user interactions are communicated to a server computer 1820 for use in creating and/or applying a data extraction plan 125.

A document 110 is presented by the client computer 1810 to a user 115 who selects a field 120 for inclusion in a data extraction plan 125. The selection of the field 120 is communicated to the server computer 1820. The field attributes 130 are identified in the server computer 1820 and used in attribute classification matching 135 to identify an ontological classification 140 in one or more ontologies 145 stored in an ontology store 1450. The ontological classification 140 is incorporated into a filter 150 for inclusion in a data extraction plan 125. The data extraction plan 125 is used in server computer 1820 to recognize data 1640 in data documents 165 and the recognized data is extracted to create extracted data 160 from one or more data documents 165. The term data document is used herein to specify a document to be processed for the recognition and extraction of data. The document 110 used in defining the data extraction plan 125 may also be used as a data document 165. The extracted data may include links to other documents and such links may be used to identify other data documents 165.

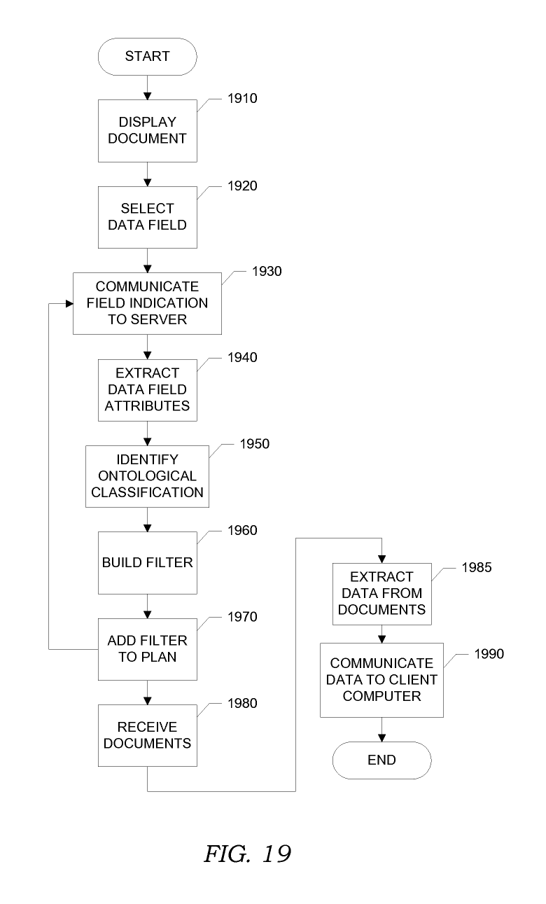

FIG. 19 is a flow diagram of an alternate embodiment using a client/server architecture. Creation of a data extraction plan 125 begins with the display by the client computer 1810 of a document 110 in step 1910 which contains data and/or links for use in defining the data extraction plan 125. The user 115 identifies a field 120 containing data or a link to another document 110 in step 1920. Identification of a field 120 may be done by selecting the field 120 in a graphical user interface, circling or highlighting a field in a document to be scanned, or otherwise differentiated from other portions of the document 110. The selected field 120 is communicated to the server computer 1820 in step 1930. The field attributes 130 associated with the identified field 120 are extracted from the document 110 in step 1940. If the document 110 is machine readable the field attributes such as text style (e.g. font, size, color, bolding, underlining), context, value and location can be extracted from the document 110. If the document 110 is printed or partially an image (for example a form document with text entry fields on an image of the form's text, lines, boxes, etc.) the document 110 may need to be processed, for example by using Optical Character Recognition, to extract the field attributes. The field attributes 130 are matched to the attributes of various potential ontological classifications 140 stored in one or more ontologies 145 in step 1950 to identify the ontological classifications 140 that match the field attributes 130. After one or more ontological classifications 140 are matched in step 1950 a selection of an ontological classification 140 or verification of the ontological classification 140 may be done by the user as described above in reference to FIG. 9.

In step 1960 the ontological classification matched in step 1950 is used to create a filter 150. The filter 150 is used to identify data in documents that match the attributes of the identified field 120. The filter 150 is then added to a data extraction plan 125 in step 1970. If additional fields are to be identified by the user as indicated in step 1970 the steps 1920 to 1970 are repeated for each additional field 120 of document 110. If no additional fields 120 are to be identified in document 110, but other documents containing fields are to be included in the data extraction plan 125 the steps 1910 to 1980 are repeated. Once all documents 110 and fields 120 are identified and the corresponding filters 150 are added to the data extraction plan 125 data documents 165 (which may include the documents 110 used in steps 210 to 280) are received in step 1980 and the plan is used in step 1985 to extract data 160 from the documents 110 received in step 1980. The extracted data 160 may then be communicated to the client computer 1810 in step 1990.

It will be appreciated that the embodiments described above are presented when the application of data extraction plans immediately after the definition of such plans for simplicity of presentation. Commonly the data extraction plans will be stored after definition and retrieved from such storage before application. Similarly, the embodiments described above do not limit the application of the data extraction plans to the same computer, system, software application or server as was used in the definition of the data extraction plan.

It will be appreciated that the embodiments described above are cited by way of example, and that the present invention is not limited to what has been particularly shown and described hereinabove. Rather, the scope of the present invention includes both combinations and sub-combinations of the various features described herein above, as well as variations and modifications thereof which would occur to persons skilled in the art upon reading the foregoing description and which are not disclosed in the prior art.

1. A method for data extraction comprising:
presenting a document to a user of a computer;
receiving from said user an input indicating a field of data in said document for use in a data extraction plan;
extracting from the document attributes of said field;
applying said field attributes to an ontology to identify an ontological classification;
building a filter based on said ontological classification to recognize data satisfying the ontological classification;
and applying said filter to extract data from other documents.

2. The method of claim 1 wherein said ontological classification is based on one or more of matching to known values, context, pattern matching and/or document structure.

3. The method of claim 1 wherein said data to be extracted is identified based on one or more of matching to known values, context, pattern matching, and/or document structure including relative positioning.

4. The method of claim 1 wherein said data to be extracted is identified by textual style.

5. The method of claim 1 wherein said ontological classification is stored in said filter.

6. The method of claim 5 wherein the type of said data is identified from said ontological classification.

7. The method of claim 5 wherein extraction of said data generates update requests to said ontological classification.

8. The method of claim 1 wherein application of said filter includes update of said filter using changes to said ontology and/or ontological classification.

9. The method of claim 1 wherein said filter is applied in response to changes to said ontology and/or ontological classification.

10. The method of claim 1 wherein applying said attributes to an ontology identifies multiple ontological classifications;
and the user identifies a preferred ontological classification.

11. The method of claim 10 wherein redundant attributes of said preferred ontological classification are removed from said filter.

12. The method of claim 10 wherein selection of said preferred ontological classification is used to adjust weighting values used to order said multiple ontological classifications.

13. The method of claim 1 wherein said filters are used to indicate the bounds of said data within said document.

14. The method of claim 13 wherein one or more filters are applied to the data within said bounds of said data within said document.

15. The method of claim 14 wherein one or more of said filters are used to extract data which may or may not be present within said bounds of said document.

16. The method of claim 1 wherein said filter may contain component filters applied to the extraction of component data from within said extracted data.

17. The method of claim 1 wherein said filter may be applicable to a portion of said document.

18. Apparatus for data extraction, comprising:
a user interface, which is configure to present a document to a user and to receive from said user an input indicating a field of data in said document for use in a data extraction plan;
a memory, configured to store program instructions; and
a processor, which is configured to execute a sequence of instructions retrieved from the memory, causing the processor to extract from the document attributes of said field, to apply said attributes to an ontology retrieved from an ontology store to identify an ontological classification, to build a filter based on said ontological classification to recognize data satisfying the ontological classification, and to apply said filter to extract data from other documents.

19. A computer software product, comprising a non-transitory computer-readable medium in which program instructions are stored, which instructions, when read by a computer, cause the computer to present a document to a user of the computer, to receive from said user an input indicating a field of data in said document for use in a data extraction plan, to extract from the document attributes of said field, to apply said attributes to an ontology to identify an ontological classification, to build a filter based on said ontological classification to recognize data satisfying the ontological classification, and to apply said filter to extract data from other documents.

20. A method for data extraction comprising:
receiving in a server from a client computer an indication a field of data selected by a user in a document displayed by the client computer to the user, for use in a data extraction plan;
extracting from the document attributes of said field;
applying said field attributes to an ontology to identify an ontological classification;
building a filter based on said ontological classification to recognize data satisfying the ontological classification;
applying said filter to extract data from other documents; and
providing said extracted data from said server to said client computer.
